(19) United States
(12) Patent Application Publication
(10) Pub. No.: US 2003/0208952 A1
(43) Pub. Date: Nov. 13, 2003

(54) Insect trap

(76) Inventor: William E. Dible, Canton, OH (US)

Correspondence Address: SAND & SEBOLT, AEGIS TOWER, SUITE 1100, 4940 MUNSON STREET, NW, CANTON, OH, 44718-3615, US

(21) Appl. No.: 10/430,973

(22) Filed: May 7, 2003

Related U.S. Application Data
(60) Provisional application No. 60/379,127, filed on May 8, 2002.

(51) Int. Cl. A01M 1/20

(52) U.S. Cl. 43/107

(57) ABSTRACT

An insect trap is disclosed. The trap is adapted to attract insects of the type that tend to naturally congregate together such as lady beetles or box elder bugs. The trap is formed from a single blank manufactured from a light-colored material. The blank has tabs extending from it and has slits cut into it. Predetermined fold lines allow the blank to be folded so that the tabs engage in the slits to form a single chambered insect trap. The blank may have images of insects marked on its outermost surface to aid in attracting insects to the trap. The trap is designed to allow insects to freely enter and exit therefrom and may be either emptied or disposed of when a suitable number of insects are held therein. The attractants used to draw insects to the trap are the use of light-colored materials for the blank, the marking of images of the desired insect onto the exterior surface of the blank and pheromones naturally released by insects attracted by the other mechanisms.

This invention claims priority from U.S. provisional application serial No. 60/379,127, filed May 8, 2002, the entire specification of which is incorporated herein by reference.

### BACKGROUND OF THE INVENTION

1. Technical Field

This invention generally relates to a trap for insects. More particularly, the invention relates to a trap for flying insects that is adapted to be mounted to a home or other structure. Specifically, the invention relates to a trap made from a single blank of sheet material that may be folded into a container for holding insects.

2. Background Information

There are a number of insects that are regarded by people as pests even though they do not cause any real property damage and pose no danger to humans. Insects such as Asian lady beetles (Harmonia axyridis) tend to congregate in large numbers on the sides of buildings. They are especially attracted to sun-illuminated walls on light colored buildings, especially in wooded areas or on hillsides. As the weather changes, they find their way into cracks and crevices in the buildings and may accumulate in places such as attics. There have been cases of these beetles accumulating up to a depth of four inches in home attics. Once warmer weather and longer days arrive, the beetles seek a way out of their warm environment and this is when they become pests for the homeowner. They may find their way into the interior of the home where they fly around light fixtures and crawl on walls and windows. In addition to the physical nuisance, if the insects are accidentally or purposefully disturbed or crushed, they emit a foul smelling and surface staining yellow liquid from their joints. In view of the large numbers of insects that may infest a property, it is difficult to find a safe way to extract the insects from the home without the use of toxic chemicals.

Another insect that may cause a similar problem is the box elder bug. These common red and black insects generally congregate on box elder trees during the summer. In the winter, however, they are attracted to cracks and crevices in homes. As the spring approaches, they come out of their winter “homes” and sun themselves on west or south facing sides of buildings. As with the lady beetle, large numbers of insects may infest homes and other structures.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a portion of a home and deck showing the insect trap of the present invention mounted on the wall of the home;

FIG. 2 is a perspective top view of the device of the present invention;

FIG. 3 is a perspective bottom view of the device showing the first step of assembly;

FIG. 4 is a perspective bottom view of the device showing the second step of assembly;

FIG. 5 is a perspective bottom view of the device showing the final step of assembly;

FIG. 6 is a cross-sectional side view of the device through line 6-6 of FIG. 1, illustrating how insects enter the device.

### DETAILED DESCRIPTION OF THE INVENTION

The device of the present invention is adapted to exploit the natural tendency of some insects to congregate. Asian lady beetles, for example, naturally tend to congregate in the fall on the sunny sides of homes and other structures. One beetle will land and then release pheromones that attracts other beetles to it. These beetles seek out a safe, dark location, such as cracks between siding, in which to overwinter.

The device of the present invention is adapted to be appealing to these insects. It is preferably made of a light-colored or light-reflecting material so as to attract the beetles to it. It is also preferably marked with images of lady beetles, for example, so that those insects are led to believe that others of their kind are already congregating at that location. Additionally, the trap may be provided with a number of entry points through which the beetles may enter the interior chamber. The beetles will naturally be drawn to these entries as they appear to be entryways to safe, dark places.

Insecticides may be placed into the trap, but as insects such as lady beetles are not harmful and may, in fact, be beneficial to the environment, it is not required. Attractants may be introduced into the trap, but as these insects release pheromones that are attractive to others of their species, it is not necessary to use other attractants.

Finally, the trap is designed to allow insects to enter and exit from it freely as it is the natural tendency of these insects to stay inside the trap. Once the trap is sufficiently full of insects, it may be disposed of or may be emptied at a remote location.

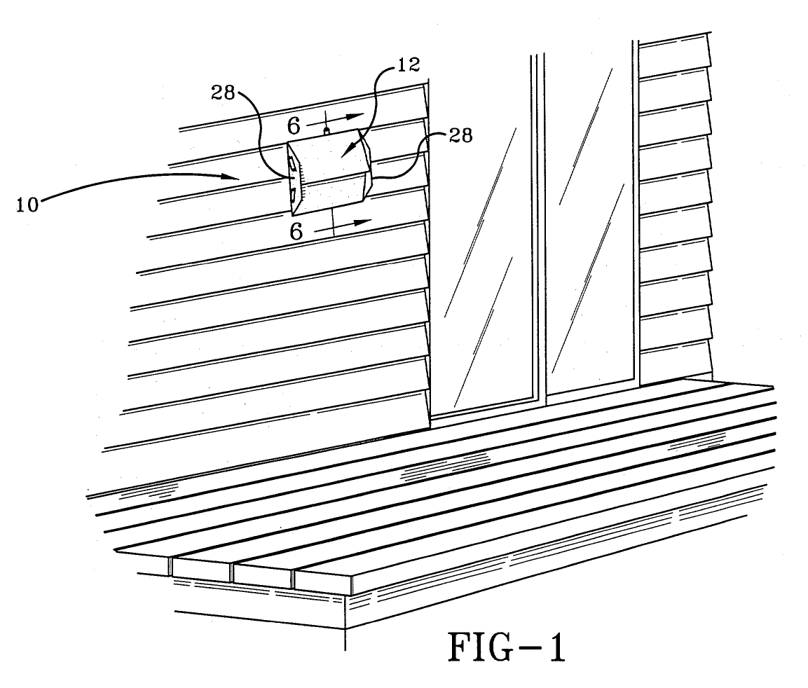

Referring to FIG. 1 there is shown the wall of a house, generally indicated by the number 10, onto which the insect trap 12 of the present invention is mounted. Wall 10 is preferably one that receives direct sunlight as this is the area of a home or other structure to which lady beetles are naturally drawn.

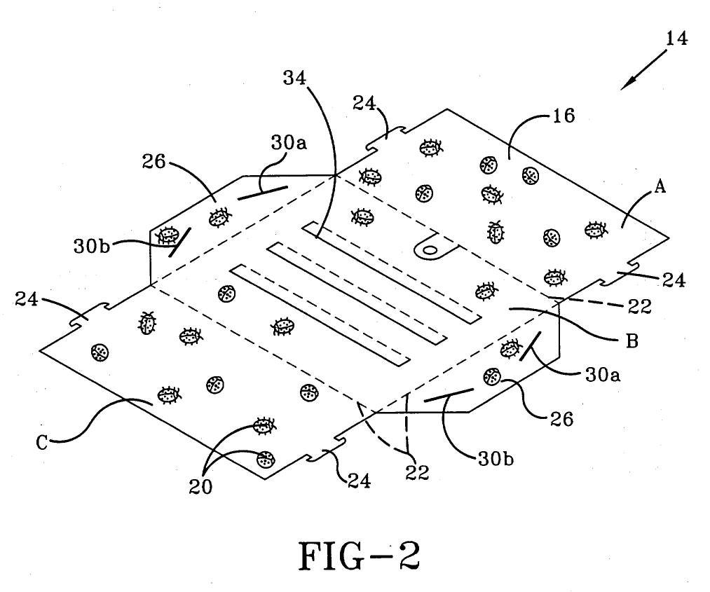

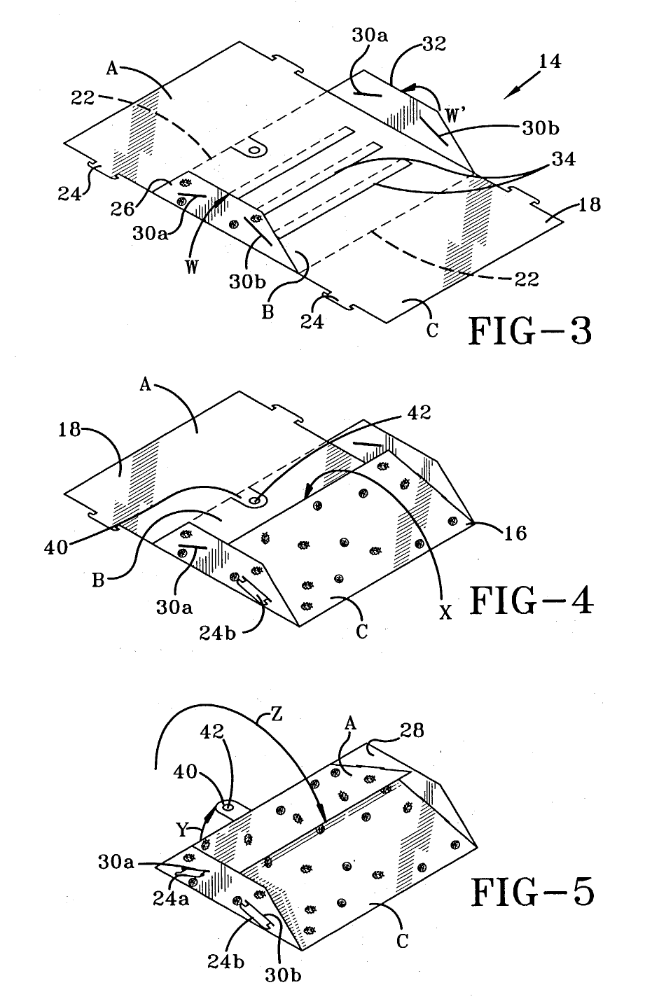

Referring to FIGS. 2 and 3, trap 12 may be formed from a single cardboard blank generally indicated by the number 14. Blank 14 is manufactured from a suitable material such as cardboard or box board. Blank 14 is generally rectangular in shape and has an upper surface 16 and a lower surface 18. Upper surface 16 is preferably light in color, e.g., white or cream, or is manufactured from a material that reflects light so as to be more attractive to lady beetles. Upper surface 16 preferably also includes a plurality of images 20 of lady beetles or other congregating types of insects such as box elder bugs.

Blank 14 may have a plurality of predetermined fold lines 22 along which it may be folded so as to form a container for insects. Fold lines 22 may either be marked onto blank 14 or be formed into blank 14 by merely thinning the material it is manufactured from in specific places. Fold lines 22 divide blank 14 into three areas generally referred to as A, B and C. Areas A and C each have a pair of first tabs 24 extending therefrom. Area B has a pair of second tabs 26 extending therefrom. Second tabs 26 are substantially larger than first tabs 24. When trap 12 is assembled, second tabs 26 form the sides 28 of trap 12 (FIG. 1). Second tabs 26 define slits 30a, 30b that are preferably positioned at an angle to each other. Additionally, slit 30a may be positioned at a different spaced distance from the edge 32 of second tab 26 relative to the position of slit 30b. First tabs 24a, 24b are adapted to engage in slits 30a, 30b when blank 14 is folded along fold lines 22. While the preferred embodiment is shown with first tabs 24a, 24b extending from areas A and C and slits 30a, 30b in area B, the first tabs may extend from area B and areas A and C may define the slits. Additionally, while two tabs 24 are shown extending from each of area A and C and two slits 30 are defined on each tab 26 of area B, any suitable number of slits and tabs may be provided on the rectangular areas.

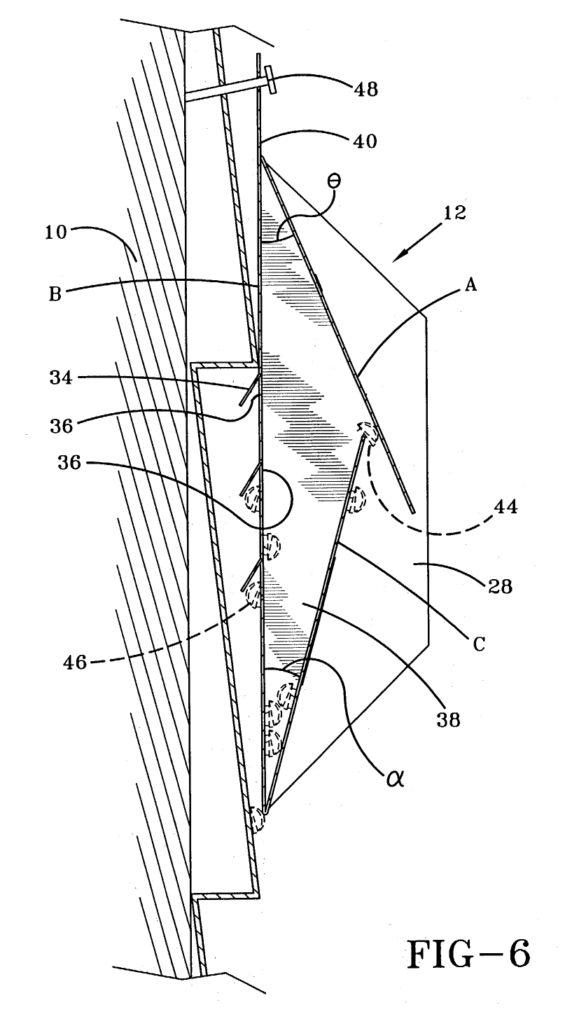

Area B of blank 14 includes a plurality of rectangular strips 34. Strips 34 may be either perforated on three sides or cut on three sides so that each strip 34 may be swung away from either the outer surface 16 or inner surface 18 of trap 12 (FIG. 6) so as to form an aperture 36. Strips 34 may be entirely removed from blank 14 if desired. While the preferred embodiment of the invention shows a plurality of strips 34 and apertures 36, trap 12 may define any other position, shape or number of ingress points into the interior 38 of trap 12 without departing from the scope of the invention.

Referring to FIG. 4, Area B of blank 14 may further include a perforated or cut out ear 40 that defines a hole 42. As shown in FIG. 5, when trap 12 is assembled, ear 40 is swung out from Area B so that it forms a generally vertical extension of Area B. A nail 48 or other suitable connecting means may then be inserted through hole 42 to secure trap 12 to a structure such as a house wall 10 (FIG. 6). While the preferred embodiment of the present invention shows an ear 40 being formed as part of blank 14, it may be manufactured separately and then secured to blank 14 by means of an adhesive or other suitable mechanism without departing from the scope of the present invention.

When trap 12 is fully assembled, an opening 44 is formed between area A and area C (FIG. 6). Insects 46 may enter the interior 38 of trap 12 through opening 44, apertures 36 or the gap (not shown) formed when ear 40 is swung away from Area B.

The device of the present invention is assembled in the following manner.

Blank 14 is positioned on a level area (not shown) so that outer surface 16 lies on the level area. Second tabs 26 are moved in the directions of the arrows W, W′ shown in FIG. 3 so that second tabs 26 are positioned generally normal to inner surface 18. Area C is moved in the direction of arrow X so that it is positioned over Area B. First tabs 24b are inserted into slits 30b so that Area C is held at an angle a to Area B. The user then pushes ear 40 out of area B and rotates it upwardly in the direction indicated by arrow Y. Area A is then moved in the direction of arrow Z so that it is positioned over Area B. First tabs 24a are inserted into slits 30a so that Area A is held at an angle θ to Area B. Trap 12 is then installed onto house wall 10 by inserting a nail 48 through hole 42 in ear 40.

Insects 46 enter trap 12 through apertures 36, opening 44 and the gap (not shown) in Area B. The structure of trap 12 allows insects 46 to enter and exit trap 12 freely. Once trap 12 is sufficiently full of insects 46, it may be removed from house wall 10 and either emptied or disposed of. Emptying trap 12 simply involves releasing first tabs 24a from slits 30a, releasing tabs 24b from slits 30b and shaking the insects 46 off the inner surface 18. If so desired, blank 14 may be refolded in the afore-mentioned manner and then be secured to house wall 10 once again.

If the user desires, an insecticide or attractant may be inserted into the interior 38 of trap 12 after first tabs 24b are inserted into slits 30b. The insecticide or attractant would then lie in the space formed between Area B and Area C of the device.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An insect trap comprising:
at least one blank having predetermined fold lines therein, said fold lines dividing the blank into a first area, a second area and a third area, wherein said third area lies intermediate said first and second areas and said third area has opposing edges with a first tab extending outwardly from each of said edges; whereby said blank may be folded along the fold lines to form a container with the first tabs forming the sides of the container, and wherein said first area partially overlaps said second area when said container is folded and a slit is formed between said first and second areas.

2. An insect trap as defined in claim 1, wherein said container is a substantially rectangular-prism-shaped container.

3. An insect trap as defined in claim 1, wherein each of the first tabs defines a slot therein and wherein the first area has opposing edges with a second tab extending outwardly from each of the first area's opposing edges, the second tabs being engageable in the slots when the blank is folded to secure the first area to the first tab.

4. An insect trap as defined in claim 3, wherein each of the first tabs defines a second slot therein, and the second area has opposing edges with a third tab extending outwardly from each of the second area's opposing edges, the third tabs being engage able in the second slots when the blank is folded to secure the second area to the first tab.

5. An insect trap as defined in claim 2, wherein said third area further defines a plurality of apertures therein, said apertures being adapted to allow insects to enter and exit the container.

6. An insect trap as defined in claim 5, wherein said apertures are disposed in parallel, spaced apart rows.

7. An insect trap as defined in claim 1, wherein the blank is manufactured from a light-reflective material.

8. An insect trap as defined in claim 1, wherein the blank is manufactured from a light-colored material.

9. An insect trap as defined in claim 8, wherein the blank is manufactured from one of a white and a cream-colored material.

10. An insect trap as defined in claim 8, wherein the blank has an inner surface and an outer surface and the outer surface is made from the light-colored material and the outer surface further includes a plurality of images of insects marked thereon.

11. An insect trap as defined in claim 10, wherein the images are of lady beetles.

12. An insect trap as defined in claim 10, wherein the images are of box elder bugs.

13. An insect trap as defined in claim 2, wherein the blank is formed from cardboard.

14. An insect trap as defined in claim 2, wherein the third area has an outer surface and an ear is disposed on the outer surface, said ear being adapted to attach the container to a supporting structure.

15. An insect trap comprising:
at least one light-colored blank with a plurality of images of insects marked upon it, the blank including a plurality of predetermined fold lines, whereby the blank is foldable along the fold lines to form a rectangular-prism shaped container adapted to attract and retain insects.

16. The insect trap as defined in claim 15, wherein the images are of lady beetles.

17. The insect trap as defined in claim 15, wherein the images are of box elder beetles.

18. The insect trap as defined in claim 15, wherein the folded blank forms a rectangular-prism shaped container.

19. The insect trap as defined in claim 15, wherein the trap may be unfolded to remove any insects trapped therein and may then be refolded to trap additional insects therein.

20. A method of trapping congregating-type insects, the method comprising the steps of:
providing an insect trap made from at least one light-colored blank with a plurality of images of insects marked upon it, the blank having predetermined fold lines thereon;
folding said blank to form a container, said container having the images of insects disposed on its outermost surface;
selecting a support surface;
securing the trap to the support surface;
waiting for a period of time to pass;
removing the trap from the support surface;
taking the trap to a location remote from the support surface.

21. The method of trapping insects as defined in claim 20, wherein the step of folding the blank includes folding the blank to form a rectangular-prism shaped container.

22. The method of trapping insects as defined in claim 20, wherein the step of selecting a support surface includes selecting a west-facing support surface.

23. The method of trapping insects as defined in claim 20, further comprising the step of:
unfolding the container and releasing the insects contained therein.

24. The method of trapping insects as defined in claim 20, further comprising the step of:
disposing of the container with the insects contained therein.

25. The method of trapping insects as defined in claim 20, further comprising the step of using an attractant to draw insects to the insect trap.

26. The method of trapping insects as defined in claim 25, wherein the step of using the attractant comprises using the naturally occurring pheromones released by previously attracted insects to draw additional insects to the trap.
